(19) United States
(12) Patent Application Publication
(10) Pub. No.: US 2020/0257660 A1
(43) Pub. Date: Aug. 13, 2020

(54) OBJECT MODEL GENERATION

(71) Applicant: CONSOLI LIMITED, Redcar and Cleveland (GB)

(72) Inventor: Christopher Barry AINSLEY, Redcar and Cleveland (GB)

(21) Appl. No.: 16/088,996

(22) PCT Filed: Mar. 24, 2017
(86) PCT No.: PCT/GB2017/050835

§ 371 Date: Sep. 27, 2018

(30) Foreign Application Priority Data
Mar. 30, 2016 (GB) 1605347.2

(51) Int. Cl. G06F 16/17; G06F 16/185; G06F 16/188

(52) U.S. Cl. CPC G06F 16/17; G06F 16/188; G06F 16/185

(57) ABSTRACT

Disclosed is a method of generating an instance of an object model from the content of a hierarchical file system, said content of the file system comprising folders and files. The method comprises generating elements within the instance of the object model, each element corresponding to at least one of the files or folders of the hierarchical file system. Each element is defined in accordance with a name of the file or folder, or plurality of files and folders, to which it corresponds and occupies a hierarchical position within the instance of the object model corresponding to a hierarchical position of the file or folder to which it corresponds. The method also comprises generating one or more sets of further elements within the object model, each set of further elements defined by a sub-object model contained within a different one of the files, wherein each set of further elements occupies a hierarchical position within the instance of the object model corresponding to a hierarchical position within the hierarchical file system of the file to which it corresponds.

### TECHNICAL FIELD

The present invention relates to techniques for generating instances of object models.

### BACKGROUND

Computer software applications are becoming ever more complex, and are required to integrate into ever more varied environments. It is not uncommon for an application to target desktop operating systems (such as Windows, Linux, OSX), a plurality of mobile operating systems (such as Android, iOS, Windows Phone), together with possible web clients (such as HTML5).

In addition, applications may be required to act differently depending on external factors (such as the deployment location, the customer, the host operating system, or whether the application is live or in a test environment).

Typically, “configuration files” can be employed to configure application functionality as per the requirements of the deployment environment. For example, a software application may contain two different code paths for two low-level graphics APIs. A configuration file may be employed to select which one to initialize when the application starts.

A configuration model may be as simple as a set of Boolean or textual flags, without concept of hierarchy. More typically, a configuration model is a hierarchical model of keys and values underneath identified headings. This latter representation type of a configuration model is often achieved by reading in JSON (JavaScript Object Notation), XML (Extensible Markup Language) or similar file formats.

A configuration model can be represented by an object model, and therefore within this document when a configuration model is referred to, this means an object model used for the purpose of configuring an application. An object model is otherwise referred to as “object model”.

A well-formed object model itself can be utilized in a plurality of ways. It can either be read and instantiated by a runtime application, from which, the application acts upon the model constructed in memory (or streamed), this is the typical “configuration model” scenario. Alternatively, the object model can be utilized by tooling such as code generators, which can use the structure hierarchical model to generate code and/or assets depending upon the contents of the model.

There can also be multiple variants of an object/configuration model that are required to be defined.

A naive, superficially simple way of defining an object model is to use monolithic configuration files (XML, JSON, or similar). Monolithic object models relate to a single execution environment (such as ‘london production’). The downside to this approach is that there may be many such environments (‘paris production’, ‘madrid production’) and it is typical for there to be a large amount of commonality between different environments. In the monolithic approach to configuration, a change that is common to all environments must be replicated across all environments. In addition, monolithic object models suffer to an environment always modifies just a single file for the purposes of source control, meaning it is difficult to visualize which areas of the object model have been modified using just source control without drilling down into the lines changed in the commit. Where an object model contains no structural differences between environments, then a “dictionary” can be employed to externalize the values of attributes so that a single configuration file can be shared by all environments. This approach however does not work if there are structural changes between environments (one environment might define four database connections, and another might define just one).

Another variant of monolithically defined (single file) configuration-models is one-file for all environments. This variant uses a pre-processor or active scripting language to make certain blocks of configuration within a file visible to only certain environments. This approach is dangerous as production and development environment details reside in the same file thus making it easy to accidentally adversely affect production environment configuration. A monolithically defined object model of either variety may also use “import” statements which are commands embedded into the configuration file requesting that resources should be loaded from another file (which itself may contain other import commands). This can reduce the size of the base configuration file, and reduce the amount of replication across all environments configuration, but, it can also create problems such as difficulty in understanding the structure of the object model “at-a-glance” and also circular dependencies (if misconfigured).

Another way of dealing with this complexity is to implement an object model using tables in a relational database. Database based object models can enforce basic referential integrity checks as per the defined schema of the database in which the configuration resides.

However, they can also be burdensome as the contents of a database are difficult to be source controlled, and then there is the license and platform limitations of running a database such that a computer software application may be difficult to port to additional platforms, setting up the database tables, and the runtime cost (time taken, memory use) in initialising from the database. A single database may also hold configurations for multiple environments or each environment may require its own database, which can involve database-administrator overhead when creating new environments. The database approach to object model instantiation is generally bespoke every time and as such can be difficult to set-up, administrate and debug.

It is an aim of the invention to define a new method of creating an easy-to-understand, source control friendly, execution-environment-aware mechanism for instantiating one or more complex object models from a plurality of files, whilst mitigating the above-mentioned drawbacks of conventional techniques for utilizing object models.

### SUMMARY OF THE INVENTION

In accordance with a first aspect of the invention, there is provided a method of generating an instance of an object model from the content of a hierarchical file system, the content of the file system comprising folders and files. The method comprises generating elements within the instance of the object model, each element corresponding to at least one of the files or folders of the hierarchical file system. Each element is defined in accordance with a name of the file or folder or plurality of files and folders to which it corresponds and occupies a hierarchical position within the instance of the object model corresponding to a hierarchical position of the file or folder to which it corresponds. The method further comprises generating one or more sets of further elements within the object model, each set of further elements defined by a sub-object model contained within a different one of the files. Each set of further elements occupies a hierarchical position within the instance of the object model corresponding to a hierarchical position within the hierarchical file system of the file to which it corresponds.

Optionally, the sub-object models contained in the files of the file system are stored using an object notation format.

Optionally, the object notation format is in accordance with JSON object notation, XML object notation or YAML object notation. Optionally, the object notation can be any format or any other hierarchical notation capable of building a hierarchical model that can be mapped to an object model.

Optionally, the files of the hierarchical file system are stored in a nominated folder.

Optionally, the generated elements of the instance of the object model include objects.

Optionally, the generated elements of the instance of the object model include collections.

Optionally, a collection is a sequence of objects.

Optionally, the generated elements of the instance of the object model include attributes.

Optionally, the method comprises, when generating the elements of the instance of the object model, ignoring selective folders and/or files based on a predefined prefix or suffix or signifier in the name of the folder and/or file.

Optionally, a merging strategy is employed to prevent or manage collisions between object elements generated with the same identification at the same hierarchical position.

Optionally, an order in which object model elements are generated within a given hierarchical level of the instance of the object model is defined using a predetermined notation in the folder name or file name.

Optionally, the method further comprises determining if a folder or file includes a predefined filter in its name, and if so when generating the elements of the instance of the object model, ignoring the folder or file unless the predefined filter matches a predetermined condition.

Optionally, the predetermined condition is based on a predetermined parameter.

Optionally, the predetermined parameter is a text string.

Optionally, the predetermined condition is based on whether or not the text string matches at least part of the text string.

Optionally, the hierarchical file system is a native file system.

Optionally, the file system is a virtual file system.

In accordance with a second aspect of the invention, there is provided a computer program which when run on a computer controls the computer to perform a method according to the first aspect of the invention.

In accordance with a third aspect of the invention, there is provided a computer program product on which is stored computer readable instructions defining a computer program according to the second aspect of the invention.

The present invention provides a way to instantiate an instance of an object model using the contents and layout of a “nominated” folder stored within a file system.

Specifically, elements of an instance of the object model are generated based on folder names and files names from folders and files stored within the nominated folder. These object model elements are arranged to occupy hierarchical positions within the object model instance corresponding to those of the folders and files from the nominated folder. Further object model elements are generated based on the content of the files.

In accordance with embodiments of the invention, the complexity normally associated with generating a plurality of different application configurations can be managed more easily, in particular in a way that reduces the complexity of individual files.

In certain embodiments, filtering techniques are deployed meaning that one folder or file may apply to many environments, or a single targeted environment.

The present invention utilizes the structure and contents of files and folders in the filesystem, not requiring explicit “import” statements, as the structure of files and folders in the filesystem act as implicit commands to import and place sub-hierarchies underneath the current context hierarchy. Implicit imports via the convention of layout (i.e. the hierarchical structure of the nominated folder) makes it easy to understand the structure of the object model at-a-glance without even opening a single file.

This approach makes it possible to drill down through a distributed object model at a file system level. This approach makes it easy to use tooling to validate smaller blocks of the distributed object model as it is modified rather than monolithic full validation.

In addition, this approach also makes it significantly easier to identify granular configuration changes in source control as each file or folder in a distributed object model would deals with a subset of identifiable concerns typically identified by the hierarchical position of the file or folder, or the object type (if supported by the embodiment) of the file or folder that has been created, modified or deleted.

Compared to conventional techniques for object model generation, the complexity of the design process is greatly reduced, and understanding of the object model structure can be achieved “at a glance”.

This can provide “at a glance” understanding of the differences between different environment object models is possible by virtue of use of embedded filters in folder names and file names.

The present invention allows files and folders to represent items in the object model alone, before even applying the contents of files to the file-system-constructed skeletal model. This is analogous to the broad brush strokes of a model being represented by the structure of files and folder, and the fine detail represented in the contents of files.

In certain embodiments, it is possible to embed type information into the name of the file or folder, such that different elements will be created depending on the file name, and the type attribute of certain elements will be set as per the naming convention of the file or folder.

This can provide “at a glance” understanding of the type of information contained within a file by virtue of reading the file name.

In certain embodiments, “merging strategies” can be deployed in order to facilitate layering/merging of certain object model elements on a per-id, per-environment basis. Layering/merging permits object model instances to be described broadly such as they apply to all environments, then per-environment details can be layered on-top. This greatly reduces repetition and is an effective tool in combatting DRY (don't repeat yourself) principles.

Various further aspects and features of the invention are defined in the claims.

### BRIEF DESCRIPTION OF FIGURES

Certain embodiments of the present invention will now be described hereinafter, by way of example only, with reference to the accompanying drawings in which:

FIG. 1 provides a schematic diagram illustrating a process for generating an instance of an object model in accordance with certain embodiments of the invention;

FIG. 2 provides a flow diagram of a process for generating an instance of an object model in accordance with certain embodiments of the invention;

FIG. 3a provides a schematic diagram depicting the structure and contents of a nominated file system folder in accordance with an exemplary embodiment of the invention;

FIG. 3b provides schematic diagrams indicating logical content of files from the nominated file system folder shown in FIG. 3a;

FIG. 4 provides a schematic diagram of an instance of an object model generated based on the content of the nominated folder depicted in FIG. 3a;

FIG. 5 provides a schematic diagram of an instance of an object model generated based on the content of the nominated folder depicted in FIG. 3a and in which certain filter information (environment=“production”) is passed to the algorithm as a context parameter;

FIG. 6 provides a schematic diagram of an instance of an object model generated based on the content of the nominated folder depicted in FIG. 3a and in which certain filter information (environment=“development”) is passed to the algorithm as a context parameter;

FIG. 7 provides a schematic diagram depicting the structure and contents of a nominated file system folder demonstrating id collisions and merging/layering optional features (independent of FIG. 3a nominated folder contents) in accordance with certain embodiments of the invention, and

FIG. 8 provides a schematic diagram indicating inputs and outputs relating to a technique using algorithm for creating an archetype.

### DETAILED DESCRIPTION

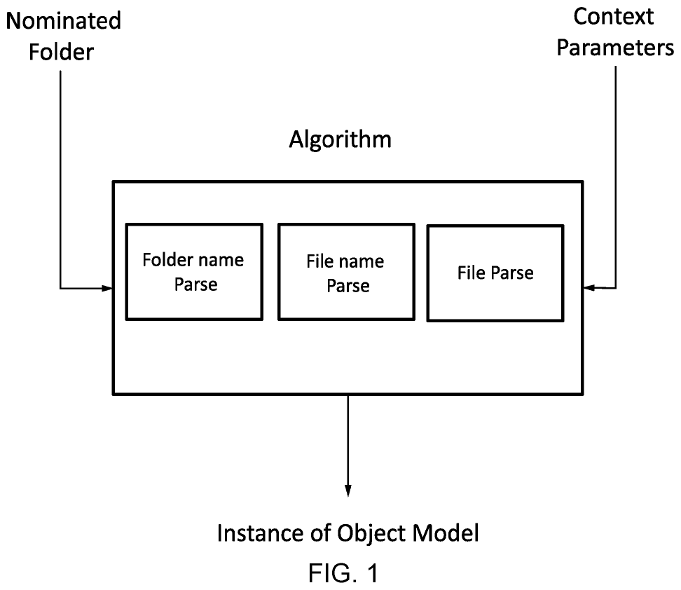

FIG. 1 provides a schematic diagram illustrating a process for generating an instance of an object model in accordance with certain embodiments of the invention.

An algorithm is performed taking as its input the content of a nominated folder of a hierarchical filesystem and, in certain examples, a number of algorithm parameters which define how the algorithm runs. These algorithm parameters are referred to as “context parameters”.

Any suitable filesystem can be used such as an OS native filesystem, application process sandboxed filesystem, in memory virtual filesystem, database backed filesystem, or key value store backed filesystem.

The nominated folder contains at least one file, representing the root object of the generated object model and any number of additional folders and files arranged in a hierarchical fashion.

The instance of the object model generated by the algorithm comprises a hierarchical arrangement of object model elements.

In order to generate the instance of the object model the algorithm extracts information (referred to henceforth as “metadata”) from the folder names and the file names of the folders and files from the nominated folder. The algorithm uses this metadata to generate object model elements.

Optionally, the algorithm also extracts further data stored within the files and uses this data to generate further object model elements.

The hierarchical arrangement of the object model elements and further object model elements generated as described above is determined based on the hierarchical position of the corresponding folders and files of the nominated for folder. That is, the hierarchical position of a given object model element corresponds to the hierarchical position, within the nominated folder, of the folder and/or file to which a given object model element corresponds.

The algorithm uses the metadata extracted from the folder names and file names to determine the nature of the corresponding object model elements that are generated.

In accordance with certain embodiments of the invention the algorithm can also use metadata extracted from the folder names and file names to “filter out” certain folders and files for the purposes of generating the instance of the object model. That is, object model elements will not be generated based on folders and files that have been filtered out.

This filtering can be conditional based on context parameters passed to the algorithm before the algorithm is run. This filtering can also be unconditional, i.e. the metadata extracted from a folder or file name dictates that folder or file is filtered out under all conditions. This can be achieved by the use of “filtering signifiers” used in folder names and files names. A filtering signifier can be a specific character, for example a leading underscore “_”. Use of a filtering signifier causes the algorithm to filter out a file or folder irrespective of any context parameters passed to the algorithm.

In certain embodiments of the invention, the algorithm designates certain files as “interesting”. A file is typically designated “interesting” if its name matches the suffix requirements of the algorithm (may require no suffix or certain described suffixes), is not filtered out by environment filters (described in more detail below), and is not filtered out by a filtering signifier.

In certain embodiments, the algorithm can be arranged to filter files based on their suffix. For example, unless a file has a particular suffix (e.g. “.ion”) it is filtered out by the algorithm.

In certain embodiments, the suffix may also be used to select an appropriate parser corresponding to the file type used to represent the sub-object-model contained within the file.

In certain embodiments, the algorithm can be configured to use a fixed parser for all “filtered-in” files, which may not require or depend on a suffix, or the algorithm may filter-in only certain suffix files and associated the particular suffixes with a particular parser.

As mentioned above, object model elements are generated based on metadata extracted from folder names and file names of the folders and files from the nominated folder. Further, certain characteristics of the object model elements are determined by the folder name or file name to which they correspond. These characteristics include a user specified name (ID), an object model element category (for example “collections” or “objects” as described further below), and in some examples a user specified type.

For example, the algorithm can be arranged to generate either an “object” element or a “collection” element based on the metadata extracted from a folder name. If the folder name includes a predetermined signifier (for example the characters “[ ]” placed after the identifier part) then a collection element is generated. On the other hand, if a folder name does not include the predetermined signifier then an object element is generated. For example, if a folder name was “example [ ]” then the algorithm would generate a collection element with the ID “example”. On the other hand if the folder name was “example”, then the algorithm would generate an object element with the ID “example”.

In certain embodiments, space characters “ ” between file or folder name parts would be ignored, but some embodiments may use spaces as signifiers themselves. For example, in certain embodiments folder name “example [ ]” and folder name “example [ ]” and folder name “example [ ]” may be logically identical for the purpose of the algorithm, extracting the same identifier and the same signifier after normalizing for whitespace.

In certain embodiments folders representing collections can contain files representing objects and folders containing objects. All interesting items underneath a folder representing a collection are added as child objects to the collection generated corresponding to the collection folder. That includes interesting files that represent objects, and interesting folders that represent objects.

In some embodiments, collections may also contain unidentified items, or even a mix of unidentified and identified items. That is, collections may contain objects without an identifier. An example name of an file-represented object within a folder-represented collection without an identifier might be “.mytype.ion”, where the identifier part is missing. An example name of a folder-represented object within a folder-represented collection without an identifier might be “{1}” or “{1}.”, using the ordering signifier in place of an identifier. It would be usual for unidentified objects within a collection to also specify a sort order signifier in their file or folder names such as “{1}.mytype.ion” or “{1}.mytype”. Specifying an order signifier allows multiple items of the same type to be provided to the same collection without using the same file or folder name twice. Other mechanisms may be deployed to avoid filename collision such as adding additional spaces adjacent to delimiter characters (delimiter characters such as “}” or “.”), or in some embodiments, or introducing other types of characters that are ignored by the file name and folder name parser (embodiment specific). It is anticipated the best approach is explicit ordering signifiers.

If a folder name is such that an object element is generated then further characteristics of the object (for example it's user specified type) can be defined by the file name of a file within the folder, said file name having an ID which matches the ID of the object. Further examples of this are provided below.

In certain examples, the algorithm is arranged to generate a single object element from metadata extracted from a folder/sub-file pair. The algorithm is arranged to determine the ID and user specified type of the object element based on the file name.

Individual interesting files, that represent objects, themselves underneath a folder that represents an object, typically must match the identifier extracted from the containing object folder; the pairing (file and folder with common extracted id) represent a single generated model element.

In certain embodiments, if a folder name is such that an object element is generated, and if the folder contains zero “interesting” files, and if the concept of type is supported in the particular object model being instantiated, then the type of the generated object can be implied to be the same as the identifier of the object extracted from the folder name. That is, a single object will be created with id corresponding to the identifier of the parent folder name, and the type of the generated object also being set to the identifier extracted from the parent folder name, that is if the concept of type is supported in the particular object model being instantiated.

Other interesting (non filtered out) files underneath a folder that represents an object, in some embodiments, can be considered to be invalid. In other embodiments, it may be permitted.

Typically, objects underneath an object folder should be represented by another object folder, not a single file representation of an object. The advantage of this approach is to avoid ID collision. In certain embodiments, an interesting (non-filtered-out) file with an ID matching that of the object folder to which it belongs is special in that the contents of its root element are added to the object generated corresponding to the containing folder. In the case of interesting files underneath a folder that represents an object with non-matching identifiers (if non-matching identifiers are permitted—which they typically are not underneath an object folder), a new object is created corresponding to the file only, that object added to the object represented by the containing folder.

For example, in one embodiment, based on the metadata extracted from the file name “example1.example.ion”, the algorithm would generate an object element with ID “example1” of the type “example”.

Typically the interesting files stored in the nominated folder and interesting subfolders of the nominated folder contain data from which the algorithm can generate further object model elements. This data is referred to as “sub-object model data”. When the algorithm has generated an object element based on the metadata extracted from a file name, further object model elements are generated based on this sub-object model data. These further object model elements have a hierarchical position in the generated object model instance below that of the object element and generated from the file name.

It should also be noted that the logical root element of the file-contained sub-object-model is ignored and only the children of the logical root element of the file-contained sub-object-model (if there are any) are added to the generated object. Specific examples of this are described below.

Reference to the “contents of sub object model” or “contents of file” are used throughout should be taken to mean where appropriate, the contents of the object model parsed from the file, excluding the root element. That is, the contents are taken to mean, the contents of the root element.

As mentioned above, the algorithm can perform conditional filtering of certain folders and files based on embedded filters in the folder names and file names. In certain embodiments an embedded filter is provided in a folder name or file name by virtue of a text string within parentheses, for example “(embeddedfilter)”. When the algorithm encounters a folder name or file name including a text string within parentheses, metadata is extracted indicating that the folder name or file name in question includes an embedded filter and the nature of that filter.

If the metadata extracted from a folder name or file name indicates a folder name or file name includes an embedded filter, then the algorithm compares this to filtering information from the context parameters. If there is deemed to be no match between the filtering information from the context parameters and the embedded filter then in certain embodiments the folder or file is filtered out, in other words, it is not-interesting, and it will not be used by the algorithm to generate object model elements for the instance of the object model.

Typically, in the event that a folder name or file name does not include an embedded filter, then it will not be filtered out (become uninteresting) by the algorithm for this reason (it may be filtered out for other reasons).

In certain examples, the filtering information passed to the algorithm as a context parameter can be a so called “environment”. An environment is a textual string that is typically used to specify the “environment” for which a particular instance of an object model is being generated.

For example, this could be a “production” environment or a “development” environment or “prod1” or “prod2” or a textual string that represents composite concerns such as “london_windows_dev”. Generally speaking it is expected that the “environment” textual string will not include whitespaces and not include special characters other than the underscore “_” character.

The nominated folder could include a number of folder names and file names including the embedded filter “production” and could include a number of folder names and file names including the embedded filter “development”.

Before the algorithm is run an environment can be passed to the algorithm via context parameters specifying values such as “development” or “production”. Based on this, folder names or file names with an embedded filter which matches the environment filter passed to the algorithm will be included in the generation of the instance of the object model.

In certain embodiments the algorithm can be arranged to process wildcard characters (for example “%”) when determining whether or not an embedded filter matches filtering information passed to the algorithm as a context parameter. For example, if an environment “production” was passed as a context parameter to the algorithm, the algorithm would match this with an embedded filter such as “prod %”, “produ %”, “% n”, “% on” and so on. In certain embodiments folder names and file names can include multiple embedded filters. For example folder name of file name could include the embedded filters “test” and “production” using these terms separated by a comma, and in parentheses: “(test, production)”. One or more matches constitutes a match.

In certain embodiments, the environment identifier alongside additional context parameters will be provided to sub-object-model parsers. That is, in some embodiments, with certain context parameters provided, it may be possible for the same sub-object-model file, parsed with the same environment to return different results based on conditional blocks that may reside in the sub-object-model file representation itself.

In some embodiments, such dynamic behaviour may be disabled using sandboxing settings provided as an additional context parameter, in which case there will be a guarantee that the same file parsed with the same parser with the same context parameters will always produce the same object model.

In some embodiments, a dictionary implementation may be passed to the sub-object-model parsers such that per-environment token substitution can occur at the parsing level. A token in this context is a placeholder for an attribute value that can be substituted for a resolved value. Depending on the parser utilized (xml, json, bespoke object notation, etc.), the dictionary may be required at parse time, or in some implementations, a dynamic token placeholder is parsed, and the dictionary substitution is applied post-object-model-generation.

As can be seen from FIG. 1, in order to extract the relevant metadata to generate the instance of the object model the algorithm includes a folder name parse process, a file name parse process and a file parse process.

In certain embodiments, additional information including signifiers may be extracted from the folder names and file names including signifiers to denote additional element types, or signifiers to denote removal of a particular element.

As mentioned above, various context parameters can be passed the algorithm before the algorithm is run including various filtering parameters such as environment. The context parameters can also include parameters which define other aspects of how the algorithm runs for example the conditions under which an error is generated, determining whether or not the algorithm is run in a particular “merge mode”, and defining ways in which files of different types of processed.

As mentioned above, an instance of an object model comprises a hierarchical arrangement of object model elements. In certain embodiments of the invention, the object model elements include “object” elements, “collection” elements and “attribute” elements.

In certain embodiments, an “object” element is an element that “contains” further elements. From a hierarchical perspective, elements contained within an object, are that object's “child” elements and the object is the child elements parent element.

In certain embodiments a “collection” element is an element that contains a sequence of objects. From a hierarchical perspective objects contained within a collection are that collection's child elements, and the collection is the child elements parent element.

In certain embodiments an attribute comprises an identifier and a value. A value can be any suitable type of payload, for example a textual field, a null value, a list of nulls/textual values or simply a binary payload.

Suitable example object notation formats include JSON, XML or YAML object notations. In certain embodiments, a bespoke object notation format may be used. Collectively, the further object model elements defined in each file are referred to as a sub-object model. As mentioned earlier, the root element of file-contained sub-object is typically discarded, and the children of the root element will be utilized.

The sub-object model data can be defined using any suitable format or file that allows the use of attributes (keys and values), objects, and optionally collections (lists or arrays of objects), to be defined (it should be noted that collections are typically optional and embodiments of the invention can be implemented without collection elements).

The encoding of the files can be in accordance with any suitable encoding scheme, for example, ASCII, UTF-8 and so on.

Default encoding of the object notation of interesting files will be embodiment specific, although it is anticipated that UTF-8 might be a sensible default for a reference implementation. Some embodiments may also allow the default encoding as it applies to parsers of interesting files to be set up via the context parameters of the algorithm. Some embodiments may be able to configure different default encodings per file type (if the embodiments supports reading a plurality of object model representation file types). Certain file types may also be able to specify their explicit encoding within the file format itself such that a standard parser would know to be able to read the file without programmatic intervention.

It should be noted that in certain object notation representations, root model elements are implicit, therefore empty files are valid. Typically, the root element of the sub-object models represented by the file will be discarded, and its contents will be added to the generated element (which may be zero entries in the case of a logically empty file).

For example, XML and JSON object notation formats are pure hierarchical representations of hierarchical information. That is, there is only one root model element and it has to be explicitly stated within the files:

XML Empty Contents Example (XML 1.0)

<anyarbitraryrootname>

</anyarbitraryrootname>

JSON Empty Contents Example

{ }

In XML/JSON, the root node is explicit, that is, a completely empty file is invalid.

As stated earlier, from the perspective of the algorithm, an “interesting” file is logically empty if the root element has no child elements. Any file that is “interesting” requires a root element. In some notations, the root element may be implicit therefore a zero byte file is a valid file to parse, and is logically empty. In XML/JSON, if the file contains zero children, then it is also logically empty.

By deprecating the value of the root element of a parsed sub-object-model, we create the opportunity to be able to define the root identifier and type from file or folder name alone.

A variation that may occur in some embodiments is that, for certain object model representation file formats (typically identified by convention or suffix), the children of a nominated branch of a sub-object model instantiated by parser will be extracted from the file, in place of the children of the root element. Only children of the nominated branch will be visible to the algorithm, if there are no children of the fixed branch, then the file will be logically empty.

Typically, the files including sub-object model definition data are designated with a predetermined suffix, for example “.xml”, “.json” or “.ion”. When the algorithm scans such a file, a sub-object model, corresponding to the sub-object model definition data is generated (via a nominated parser). Typically, the contents of the discarded root element of the parsed sub-object model occupy a hierarchical position within the instance of the object model corresponding to the generated object instance of the file system element (file or folder or file-folder pair) from which it was generated.

That is, the children of the root element of the sub-object-model are added to generated object instance corresponding to the file system element (file or folder or file-folder pair) from which the object model element was generated.

Thus is will be understood that it is the children of the sub-object model that are added to the generated object model element to which the file/folder or file-folder pair corresponds.

If the embodiment-specific object model supports such a feature, the path of the file from which a sub-object model is loaded, or the folder which contains the file from which a sub-object model is loaded, can be attached to each model element generated by the algorithm, or can be attached to a subset of created model element in the sub-object model.

In addition, model elements that are generated from file system files and folders should also embed the file path of the file system element into the generated model element itself. In cases where elements are generated from file/folder pairs, one file path will be chosen and stored.

Attaching the filesystem origin, as described previously, to generated object model elements is entirely optional, but the benefit of implementing this feature is be able to pinpoint the exact location in which a misconfiguration occurs downstream in client code.

In certain embodiments, specific further characteristics are defined for object elements and collection elements.

For example:
An object can contain zero or more elements (attribute, objects, collections).
An object contained within another object must have an identifier.
All objects (except the root object) must have a type.
The root object does not have a type or an identifier.
All elements within an object must have an identifier.
Identifiers corresponding to child elements of a given object must be unique within that object.
A collection is a sequence of one or more objects.
A collection always has an identifier.
A collection does not have a type.
Objects contained in a collection must have a type.
Objects contained in a collection may also have an identifier but this is optional.
Identifiers corresponding to child elements of a given collection must be unique within that collection.
A collection may internally record if insertion order is maintained or order unmaintained. That is, API access to a collection may ask if order is guaranteed to be the same as insertion order, or if order is not guaranteed to be the same as insertion order.

In certain embodiments, the order with which object model elements are generated within a given hierarchical level of the instance of the object model (the “insertion order”) is not defined. In other embodiments the insertion order can be defined using a predetermined notation in the folder name or file name. For example, brace brackets can be used, within which a positive integer is included. For example, a folder name “{1}example_customer” would specify an object element with ID “example_customer” is to be generated. The integer “1” in the brace brackets indicates that this object element is to be inserted in its parent object model element first—i.e. before any other object model elements that are at the same hierarchical level. If the parent object element is a collection element, and if the object model embodiment supports it, any item added to a collection element that does not contain ordering information, if supported by the object model, will set a flag on the containing generated collection element signalling that the collection is “unordered”. The purpose of this flag is to detect that order information may have been lost by representing the contents of the collection on the file system using this invention.

In some implementations the order information contained within the brace bracket may be evaluated as a string, in others, it may be converted to an integer before used for ordering purposes. In some implementations, ordering may be performed low to high, in other implementations, ordering may be performed high to low. In some implementations, duplicate integer or string values are permitted, in others, duplicate values are not permitted.

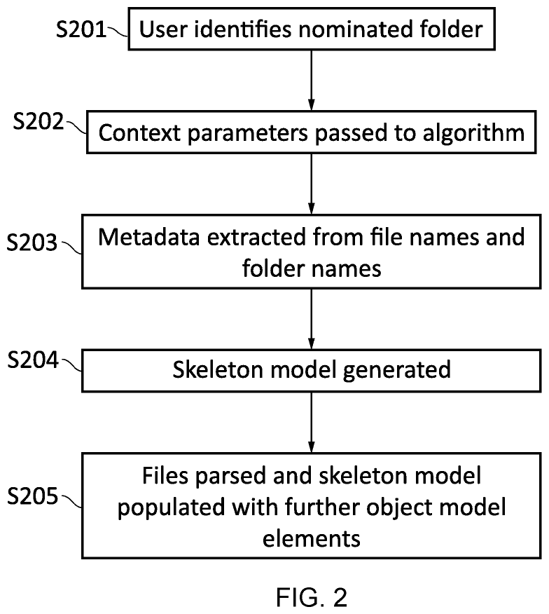

FIG. 2 provides a flow diagram of a process for generating an instance of an object model in accordance with certain embodiments of the invention.

At a first step S201 the user identifies a nominated folder the structure and contents of which will be used to generate the instance of the object model.

At a second step S202 context parameters, as described above, are passed to the algorithm to control aspects of how the algorithm runs. In certain embodiments, the user nominated folder could be identified in the context parameters.

The algorithm then runs performing the third step S203, the fourth step S204, and the fifth step S205.

At the third step S203 metadata is extracted from the file names and folder names as discussed above.

At the fourth step S204 the algorithm generates object model elements based on the folder names and file names as described above. The algorithm generates a “skeleton” object model from these object model elements. The hierarchical structure of the skeleton object model corresponds to the hierarchical arrangement of the folders and files from the nominated folder which corresponds to the generated object model elements.

At the fifth step S205 the algorithm parses the content of the various files, specifically the sub object model data stored therein, to generate further object model elements and populates the skeleton model with these further object model elements.

An instance of the object model is thus generated and can be output and stored in any suitable format.

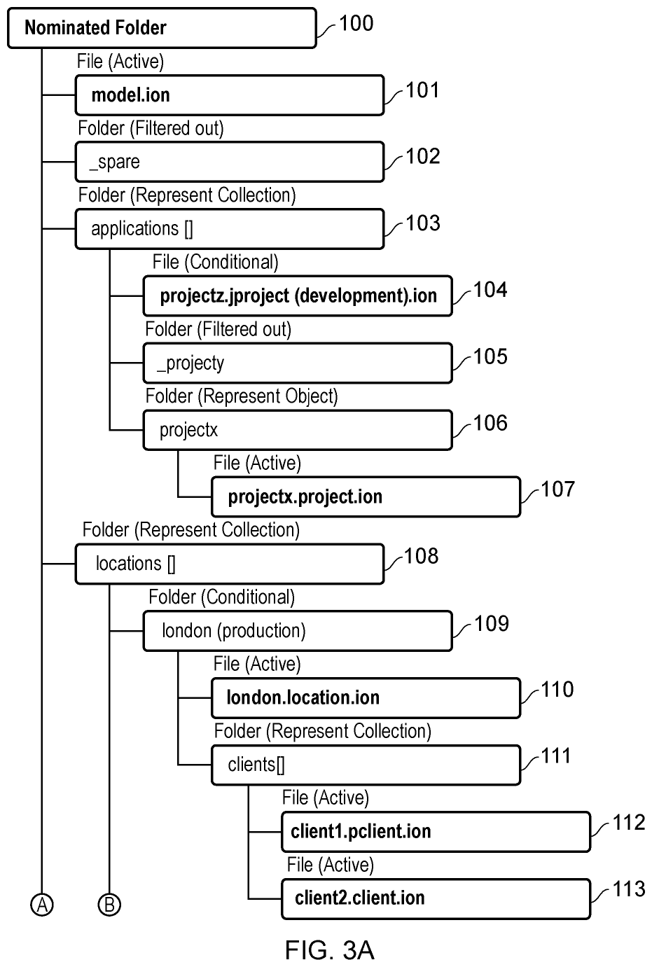

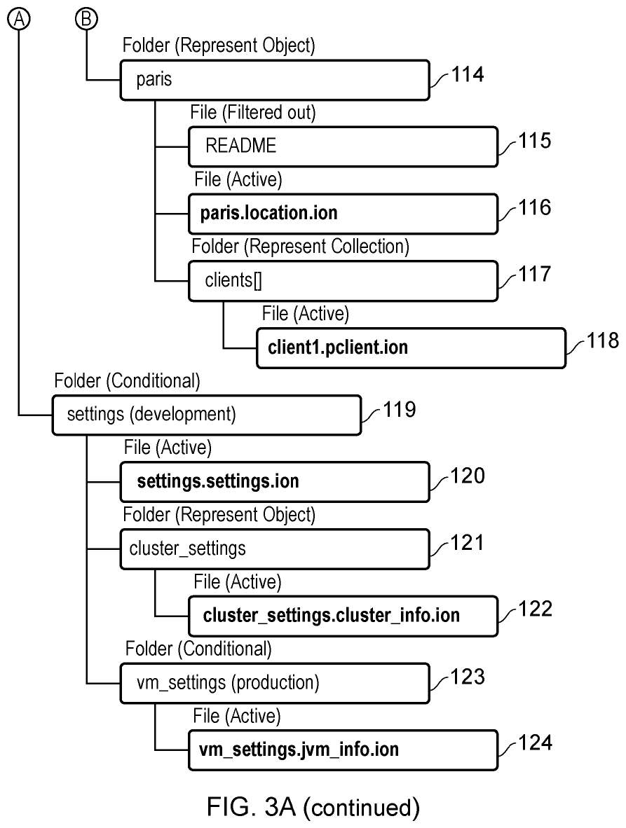

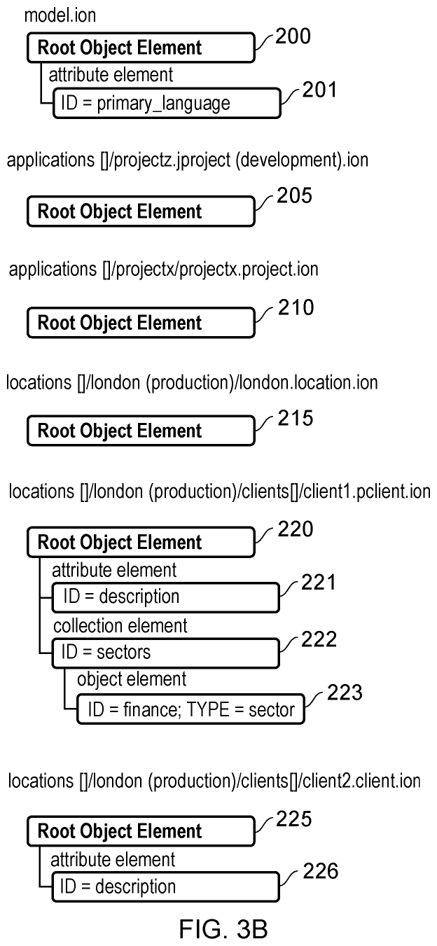

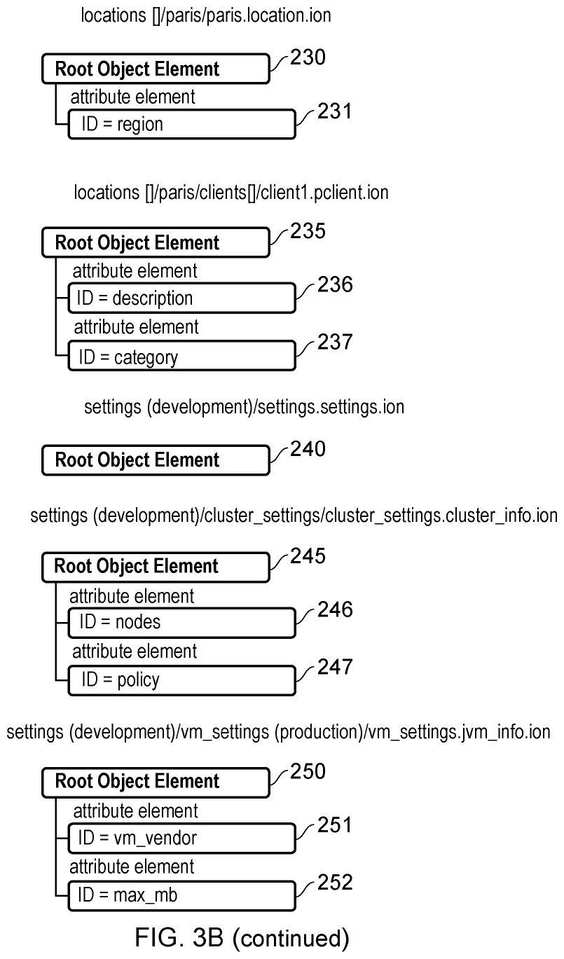

An example of this process is explained in more detail with reference to FIGS. 3a to 6.

FIG. 3a provides a schematic diagram depicting the structure and contents of a nominated folder.

In describing FIGS. 3a, 3b, 4, 5 and 6, the following is assumed for the example embodiment of the algorithm:
File suffix “.ion” is required in order for a file to be interesting.
An underscore “_” character as a prefix to a file or folder will mark that file or folder branch uninteresting.
A suitable parser is available for loading sub-object models from files ending in “.ion”.
The “[” and “]” characters in sequence, ignoring whitespace, will be used to denote a “collection” object model element type.
Objected types are supported in the sample embodiment.

Turning to FIG. 3a, the root folder, “Nominated Folder” 100, contains a number of sub-folders: “_spare” 102, “applications [ ]” 103, “locations [ ]” 108 and “settings (development)” 119

Each of these folders, excluding “_spare” 102, contains a number of further folders and/or 25 files.

For example, the folder “applications [ ]” 103 contains the sub-folders “_projecty” 105 and “projectx” 106.

Further, as can be seen, hierarchically, the root folder 100 contains a number of interesting files, namely “model.ion” 101, “projectz.jproject (development).ion” 104, “projectx.project.ion” 107, “london.location.ion” 110, “client1.pclient.ion” 112 (within the folder “london (production)” 109), “client2.client.ion” 113, “paris.location.ion” 116, “client1.pclient.ion” 118 (within the folder “paris”), “settings.settings.ion” 120, “cluster_settings.cluster_info.ion” 122 and “vm_settings.jvm_info.ion” 124. Typically, each of these files may contain sub-object model data or may contain logically empty contents (no children below the discarded root element).

“README” 115 is ignored by the algorithm due to it failing to match the expected file suffix (“.ion”) for files in the example embodiment.

Example content of these files are described with reference to FIG. 3b.

As can be seen from FIG. 3a, “model.ion” 101 is a file underneath the nominated folder 100. The file contains a representation of a sub-object model. The sub object model consists of a root element 200, which itself contains a single attribute element 201 with an identifier of “primary_language”. The value of attribute element 201 is not shown in the diagram.

The file “projectz.jproject (development).ion” 104 is a file underneath folder “applications [ ]” 103, which itself is underneath the nominated folder 100. The filename embeds an environment filter between “(“and”)” brackets with value “development”. The file contains a representation of a sub-object model. The file is logically empty for the purpose of the algorithm in that it only contains a root element 205. That is, in some embodiments, the file may contain zero bytes and the root object is implicitly created with empty contents. XML files with a single root element are also logically empty by this definition in that it is the contents of the root element that are utilized, not the root element itself.

The file “projectx.project.ion” 106 is a file underneath folder “applications [ ]” 103, which itself is underneath the nominated folder 100. The file contains a representation of a sub-object model. The file is logically empty for the purpose of the algorithm in that the object model representation contained within only contains a root element 210.

The file “london.location.ion” 110 is a file underneath folder “london (production)” 109, underneath folder “locations [ ]” 108 which itself is underneath the nominated folder 100. The file contains a representation of a sub-object model. The file is logically empty for the purpose of the algorithm in that the object model representation contained within only contains a root element 215.

The file “client1.pclient.ion” 112 is a file underneath folder “clients [ ]” 111 itself underneath folder “london (production)” 109, underneath folder “locations [ ]” 108 which itself is underneath the nominated folder 100. The file contains a representation of a sub-object model consisting of a root element 220, which itself contains two sub-elements. The first element is an attribute element 221 with an identifier of “description”. The value of attribute element 221 is not shown in the diagram. The second element underneath root element 220 is collection element 222, with an identifier of “sectors”. This element 222 itself contains an object elements 223, which has an identifier of “finance” and a type of “sector”. Object element 223 does not contain any sub-elements.

The file “client2.client.ion” 113 is a file underneath folder “clients [ ]” 111 itself underneath folder “london (production)” 109, underneath folder “locations [ ]” 108 which itself is underneath the nominated folder 100. The file contains a representation of a sub-object model consisting of a root element 225, which itself contains a single child element. child element is an attribute element 226 with an identifier of “description”. The value of attribute element 226 is not shown in the diagram.

The file “paris.location.ion” 116 is a file underneath folder “paris” 114, itself underneath folder “locations [ ]” 108 which itself is underneath the nominated folder 100. The file contains a representation of a sub-object model consisting of a root element 230, which itself contains a single child element. Child element is an attribute element 231 with an identifier of “region”. The value of attribute element 231 is not shown in the diagram.

The file “client1.pclient.ion” 118 is a file underneath folder “clients [ ]” 117 itself underneath folder “paris” 114, underneath folder “locations [ ]” 108 which itself is underneath the nominated folder 100. The file contains a representation of a sub-object model consisting of a root element 235, which itself contains two sub-elements. The first element is an attribute element 236 with an identifier of “description”. The value of attribute element 236 is not shown in the diagram. The second element underneath root element 235 is attribute element 237, with an identifier of “category”. The value of attribute element 237 is not shown in the diagram.

The file “settings.settings.ion” 120 is a file underneath folder “settings (development)” 119, which itself is underneath the nominated folder 100. The file contains a representation of a sub-object model. The file is logically empty for the purpose of the algorithm in that the object model representation contained within only contains a root element 240.

The file “cluster_settings.cluster_info.ion” 122 is a file underneath folder “cluster_settings” 121 itself underneath folder “settings (development)” 119, which itself is underneath the nominated folder 100. The file contains a representation of a sub-object model consisting of a root element 245, which itself contains two sub-elements. The first element is an attribute element 246 with an identifier of the file “nodes”. The value of attribute element 246 is not shown in the diagram. The second element underneath root element 245 is attribute element 247, with an identifier of “policy”. The value of attribute element 247 is not shown in the diagram.

The file “vm_settings.jvm_info.ion” 124 is a file underneath folder “vm_settings (production)” 123 itself underneath folder “settings (development)” 119, which itself is underneath the nominated folder 100. The file contains a representation of a sub-object model consisting of a root element 250, which itself contains two sub-elements. The first element is an attribute element 251 with an identifier of “vm_vendor”. The value of attribute element 251 is not shown in the diagram. The second element underneath root element 250 is attribute element 252, with an identifier of “max_mb”. The value of attribute element 252 is not shown in the diagram.

As described above, in accordance with certain embodiments of the invention, a user will identify the root folder “Nominated Folder” 100 as the folder on which the algorithm is to operate. Alternatively, the user may provide the root file in a nominated folder, either way the nominated folder and can imply the root file if it is the only interesting file in the nominated folder. Context parameters can be passed to the algorithm, for example, specifying an environment filter “production”. Metadata is then extracted from the folder names and file names.

Filtering metadata is then extracted from all of the folder names and file names that include an embedded filter, namely “projectz.jproject(development).ion” 104, “london (production)” 109, “settings (development)” 119, and “vm_settings (production) 123”.

Filtering metadata is also extracted from the folder name “_spare” 102 and the folder name “_projecty” 105 because of use of the filtering signifier “_”. These folders are filtered out by the algorithm.

In certain embodiments, as described above, the instance of the object model is generated in a “linear” fashion. That is, metadata is extracted from all of the folder names and files names, a complete skeleton model is then generated and the skeleton model is then populated with the further object mode elements from the sub-object model data.

However, in certain embodiments, the third fourth and fifth steps described with reference to FIG. 2 can be performed on different parts of the nominated folder at different times to generate an instance of an object model “recursively”. For example, the algorithm may generate all of the object model elements to the end of one particular hierarchical branch before generating object model elements for the next hierarchical branch. That is, the skeleton model is not generated first and then the file contents added, instead full branches are built recursively. The first branch of the skeleton is built, then file contents added, then the next skeleton branch is built, then the file contents added and so on.

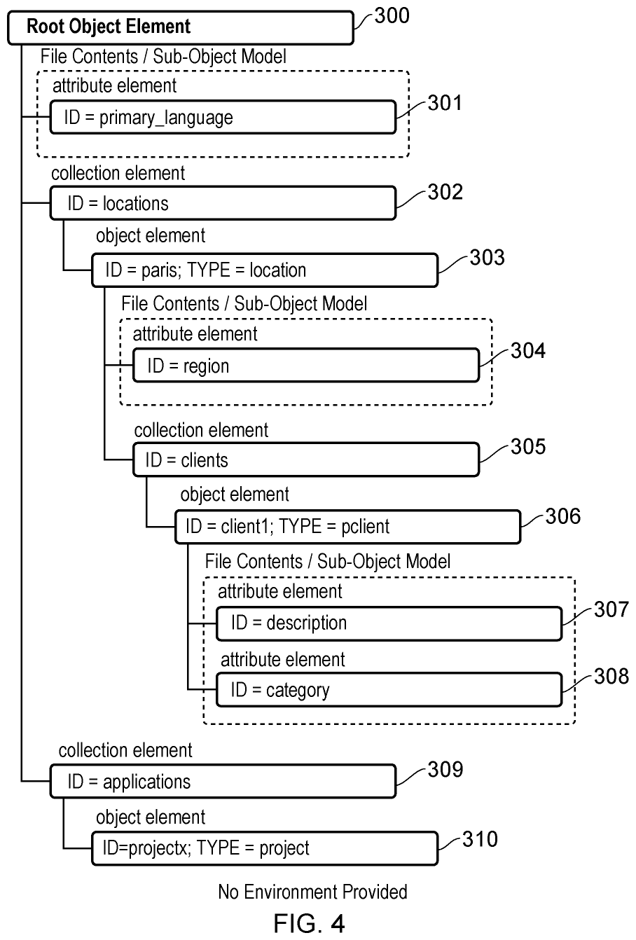

Thus, with reference to FIG. 4, for example, the branch of the instance of the object model of which the collection object element “ID=locations” 302 is the parent is generated completely (all the way to the sub object model with the object element “ID=client1; type=pclient 306”, and its children 307, 308), before the algorithm generates the collections element “ID=applications” 309.

Object element category metadata is extracted from the folder names and file names. The object element category metadata extracted from folder names “projectx” 106, “london (production)” 109, “paris” 114, “settings (development)” 119, “cluster_settings” 121 and “vm_settings (production)” 123 specifies that object model elements generated based on these folder names should be object elements because these folder names do not include the embodiment specific collectionsignifier (e.g. do not include the embodiment specific collectionsignifier “[ ]”).

In certain embodiments, files are only “interesting” if they have a certain suffix. However, the suffix requirement is entirely optional. If the algorithm only “sees” files with a suffix it allows for additional assets to be stored alongside the model (such as a “README” 115 file), without it interfering with the function of the algorithm.

On the other hand, the object element category metadata extracted from folders “applications [ ]” 103, “locations [ ]” 108, “clients [ ] 117” (within the folder “london (production)”), and “clients[ ]” (within the folder “paris”) specifies that the object model element generated based on these folder names should be collection object elements because these folder names include the prefix “[ ]”.

If “interesting” the algorithm generates an object element for each of the file names (“projectz.jproject(development).ion” 104, “project.project.ion” 107, “london.location.ion” 110, “client1.pclient.ion” 112 (within the folder “london (production)” 104), “client2.client.ion” 113, “paris.location.ion” 116, ““client1.pclient.ion” 118 (within the folder “paris” 114), “settings.settings.ion” 120, “cluster_settings.cluster_info.ion” 122 and “vm_settings.jvm_info.ion” 124). This is because the algorithm is arranged to generate object elements based on files names.

In some embodiments, where an interesting file (meets suffix, environment filter, no filtering out signifier, file name correctly structured) is present within a folder that represents an object, then if the identifier matches that of the identifier extracted from the containing folder, then only a single object model element will be generated for the two file system items (file and folder).

As described earlier, the file suffix is optional based on the embodiment, but in certain examples, the lack of a file suffix will mark a file as non-interesting to the algorithm (in addition to other ways that a file can be flagged non-interesting such as the embodiment specific filtering signifier “_” or the environment specific filters “(production)”).

ID metadata is extracted from the folder names and files names. For example, ID metadata “applications” is extracted from the folder name “applications[ ]” 103, ID metadata “london” is extracted from the folder name “london (production) 109”, ID metadata “paris” is extracted from the folder name “paris” 114, ID metadata “projectz” is extracted from the file name “projectz.jproject(development).ion” 104.

As mentioned above, in some embodiments, object elements can have a user specified type. User specified type metadata can be extracted from file names based on a text string in a predefined position, for example after the first “.” character of a file name to the next significant marker character (for example “(” or “.” or possibly end of line if there is no suffix requirement). Thus, for example, the user specified type of “jproject” is extracted from the file name “projectz.jproject(development).ion” 104.

For folder names which represent objects (without the “[ ]” signifier in some embodiments), in embodiments that support object “type” metadata, the user specified type metadata can be extracted from a file name, with a corresponding ID to the folder name, stored within the folder in question. Thus the name of the file “london.location.ion” 110 specifies user specified type metadata “location” to be associated with the metadata extracted from the folder name “london (production)” 109.

If “london.location.ion” 110 were not present underneath folder “london (production)” 109, then in embodiments that support “type” metadata, the type may, embodiment-specific, fall back to be the same as the identifier extracted from the folder, both id and type would be “london”.

Files underneath an “interesting” folder that represents an object, where the extracted id from the folder does not equal the extracted id from the parent folder, are generally not permitted. It would be embodiment specific or context parameter specific if this would be flagged as an error, if non-matching files would be ignored, or if they would be treated as if their parent element was a collection (generally only files with an extracted id matching the id extracted from the parent folder are permitted within a folder representing an object).

With the metadata extracted as above, the algorithm is arranged to generate a skeleton model comprising object model elements based on the metadata extracted from the folder names and file names. The algorithm then populates the skeleton model with the object model elements defined underneath the respective logical root elements of the sub-object model data of the respective files. Or the operation can occur recursively as discussed earlier. The instance of the object model is thus generated.

FIGS. 4, 5 and 6 correspond to an embodiment in which files are flagged as uninteresting unless their names end in the “.ion” suffix. The suffix requirement can be both embodiment and context parameter specific. Folders and files are also flagged as uninteresting if their names start with the underscore “_” character. In addition, folders and files are flagged as uninteresting if they specify filter information, and the current environment context parameter text string does not match the specified pattern or patterns specified between the embodiment specified “(“and”)” characters.

FIG. 4 depicts a schematic diagram of an instance of an object model generated based on the nominated folder explained with reference to FIG. 3a.

FIG. 4 depicts an example in which no “environment” has been passed to the algorithm in the context parameters. In this way, all of the folders and files that include an embedded filter in their name, (“projectz.jproject(development).ion” 104, “london (production)” 109 and “settings (development)” 119, are excluded by the algorithm during the generation of this object model instance. This means that no object model elements will be generated corresponding to the excluded folder names and file names of the excluded folders and files along with the content of any of the excluded folders and files.

“vm_settings (production)” 123 would also be excluded too, but as “settings (development)” 119 was already excluded, everything underneath an excluded/uninteresting folder is automatically excluded. Uninteresting/excluded status propagates downward.

FIG. 4 shows a first attribute element 301 “ID=primary_langauge” corresponding to the content of the file “model.ion” 101 from the nominated folder described with reference to FIG. 3a.

FIG. 4 shows a first collection element “ID=locations” 302 corresponding to the folder “locations [ ]” 108 from the nominated folder shown in FIG. 3a. The first collection element “ID=locations” 302 includes within it a first object element “ID=paris; type=location” 303 corresponding to the folder “paris” 114 and the file “paris.location.ion” 116 from the nominated folder.

The first object element “ID=paris; type=location” 303 is generated from folder “paris” 114 and “paris.location.ion” 116. The contents of sub object model data parsed from the “paris.location.ion” 116 file are added to the created object, 303. The root element 230 of the parsed contents of file “paris.location.ion” 116 is discarded, and its children (231) are added to the generated object “ID=paris; type=location” 303. An attribute element “ID=region” 304 is contained within the “ID=paris; type=location” 303 file.

The first object element “ID=paris; type=location” 303 also includes within it a first collection element “ID=clients” 305 which corresponds to the folder “clients [ ]” 117 underneath “paris” 114, itself underneath “locations [ ]” 108, underneath the nominated folder 100.

The collection element “ID=clients” 305 includes within it an object element “ID=client1; type=pclient” 306 corresponding to the file name of the file “client1.pclient.ion” 118 from the nominated folder. The object element “ID=client1; type=pclient” 306 contains within it a sub object model (indicated by the broken line) including an attribute element “ID=description” 307 (corresponds to 236) and attribute element “ID=category” 308 (corresponds to 237). This sub-object model corresponds with the content of the file “client1.pclient.ion” 118 (children of the discarded root model element of the sub-object model).

The instance of the object model also includes a collections element “ID=applications” 309 corresponding to the folder “applications [ ]” 103 from the nominated folder. The collections elements “ID=applications” 309 contains an object element “ID=project; type=project” 310 corresponding to the folder “projectx” 106 and the filename from the file “projectx.project.ion” 107 from the nominated folder (folders that represent objects typically create a single object model element per folder/file pair with matching id, or create an object per-folder if there does not exist a file with matching id within the folder).

As can be seen by comparing FIG. 3a with FIG. 4, the hierarchical positions of the object elements of the instance of the object model correspond to the hierarchical positions within the nominated folder of the folders and/or files to which they correspond.

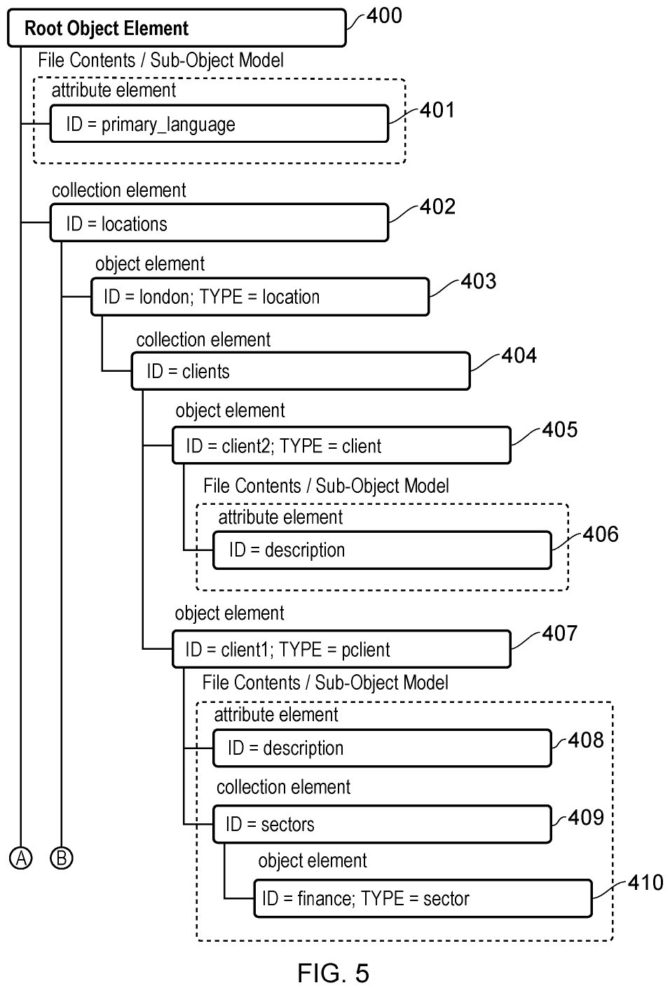

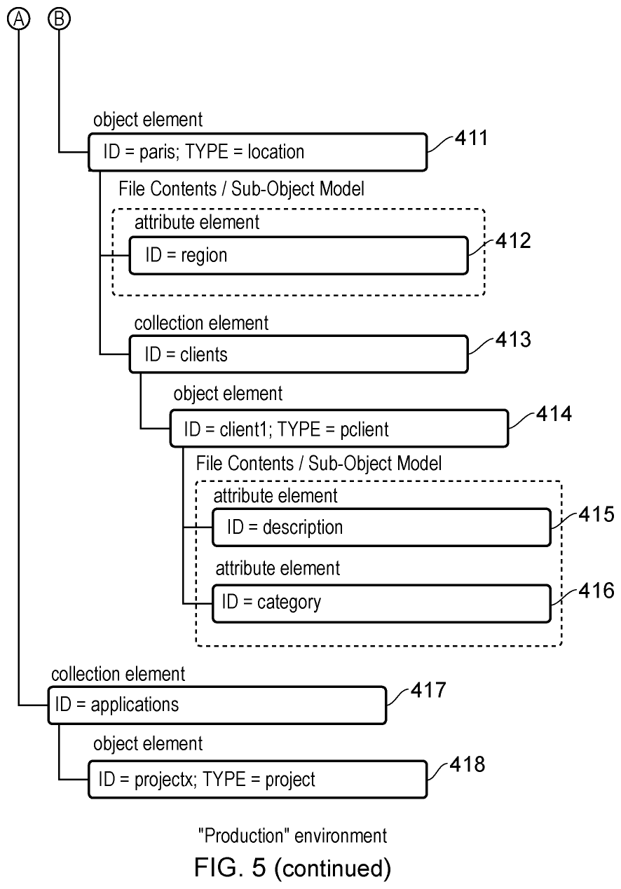

FIG. 5 provides a schematic diagram of an instance of an object model generated after the algorithm has been applied to the nominated folder shown in FIG. 3a and in which filter information has been passed to the algorithm in the context parameters. The filter information specifies the environment filter “production”. Accordingly, the algorithm generates the instance of the object model using all of the folders and files without an embedded filter (as was the case with the instance of the object model explained with reference to FIG. 4), but also includes folders and files with the embedded filter “production”. In the case of the content of the nominated folder shown in FIG. 3a, this will include folder “london (production)” 109. Notice that in FIG. 5, object element “ID=client2; TYPE=client” 405, appears before object element “ID=client1; TYPE=pclient” 407. This is because the order in which files are loaded from the file system is undefined in the example embodiment. Also note that the folder “vm_settings (production)” 123 is also filtered out despite including the embedded filter “production” because its parent element, the folder “settings (development)”, is filtered out when the context parameters specify only production as filter information of the context parameters.

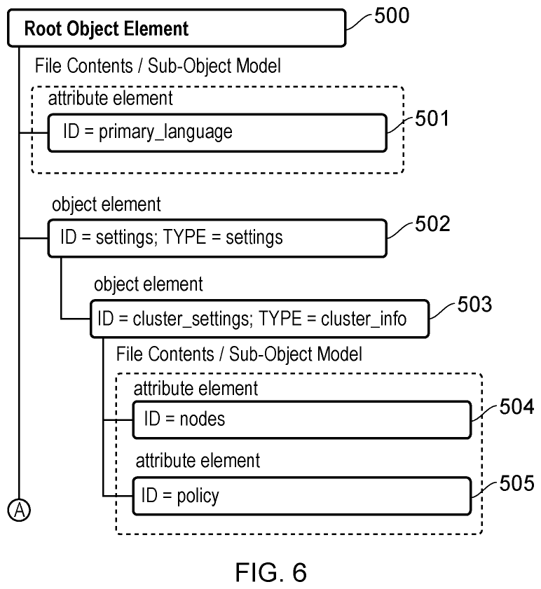

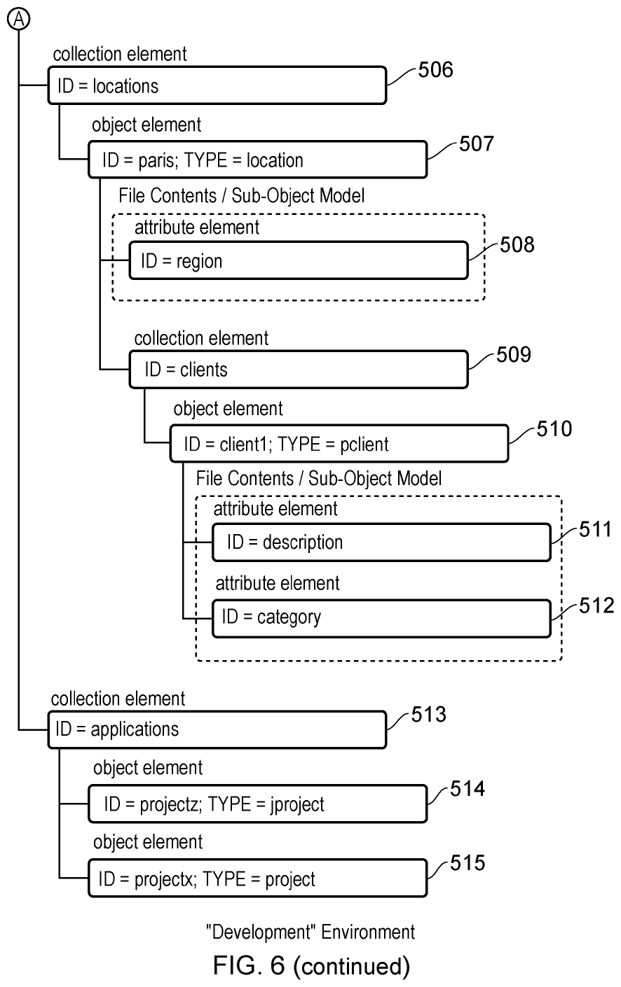

FIG. 6 provides a schematic diagram of an instance of an object model generated after the algorithm has been applied to the nominated folder shown in FIG. 3a and in which filter information has been passed to the algorithm in the context parameters. The filter information specifies the environment filter “development”. Accordingly, the algorithm generates the instance of the object model using all of the folders and files without an embedded filter (as was the case with the instance of the object model explained with reference to FIG. 4), but also includes folders and files with the embedded filter “development” namely the file “projectz.jproject(development).ion” 107, and the folder “settings (development)” 119.

In certain embodiments of the invention, an object element generation “collision” may occur, for example, if two separate folders or files cause two object model elements to be generated with the same ID. In such situations the algorithm can employ one of a number of “merging strategies” which define how the algorithm generates object model elements in the event of such a collision.

ID Collisions may also occur by design in order to facilitate model element merging/layering, which is a technique where general information is instantiated from a file/folder/file-folder-pair, and then more specific information is loaded via a more specific folder or file with an environment filter. Layering allows the user to specify default values in a folder named “settings” for example, before layering in per-environment additions/overrides such as “settings (development)” for example. It also allows the “mirroring” of non-filtered file system items with filtered items.

A first example merging strategy can be that merging is “disabled”. In other words, in the event that two files or folders exist that would map to a generated object model element with the same identifier at the same level, then an application exception would be thrown.

In a second example merging strategy, “additive changes” are permitted but no overrides. That is, the algorithm generates the first instance of the object model element, and adds to this object model instance any additional elements that are defined by the second instance of the object model element. However, overrides (changes to existing elements of the object model element generated from the first instance of the object model element) are not permitted. Merges occur recursively. That is, if within an outer folder “model” there exist two sub-folders “settings” and “settings (development),” and if within the “settings” folder, there exists a file “settings.settings.ion” which contains under the root element two attributes, “a” and “b”. In addition, if within the “settings (development)” folder (underneath the “model” folder) there exists a file “settings.settings.ion” and within that file, there is contained under the root element attribute “c”, then both folders would map to the same generated object model element in the skeleton model. In “additive changes” merge mode, the “settings” object with a type of “settings” (in embodiments that support type) would be generated underneath the outer “model” object element. “a” and “b” would be added to the “settings” object first, then “c” would be added to the settings object. Collisions of sub-object model data would generally not be permitted in this mode, meaning that if the “settings.settings.ion” file within the “settings” folder contained additional attribute “c”, then there would be a merge collision as the value of “c” would not be permitted to be modified, in an attempt to prevent ambiguity. Merging occurs recursively, and collisions of objects that share the same type recursively would generally be permitted, it would be collisions in attribute values that would be not be permitted.

In a third example merging strategy “replace”, any content of an object is able to be overridden. That is, if within an outer folder “model” there exist two sub-folders “settings” and “settings (development),” and if within the “settings” folder, there exists a file “settings.settings.ion” which contains under the root element two attributes, “a” and “b”. In addition, if within the “settings (development)” folder (underneath the “model” folder) there exists a file “settings.settings.ion” and within that file, there is contained under the root element attribute three attributes “a”, “c” and “d”, then both folders would map to the same generated object model element in the skeleton model. In “replace” merge mode, the “settings” object with a type of “settings” (in embodiments that support type) would be generated underneath the outer “model” object element. “a” and “b” would be added to the “settings” object first, then the “a”, “c” and “d” would be added to the settings object (from the file underneath “settings (development)” folder. Collisions of sub-object model data would generally be permitted in this mode. Merging occurs recursively, and collisions of objects that share the same type recursively would generally be permitted, it would be collisions in attribute values that would be not be permitted.

Variants of merging strategies can be specified per embodiment or configurable via the context parameters of a particular embodiment.

Variants may include the ability to override the type of an object model element in a merge (such as replacing object with an attribute, attribute with an object, or object with a collection, and so on).

Another variant that can be specified per embodiment or configurable via the context parameters of a particular embodiment is the ability to specify if to generation the union of colliding collections or replace an entire collection entirely upon collection collision.

Another variant that can be specified per embodiment or configurable via the context parameters of a particular embodiment is the ability to specify if one object model element type can be replaced with another type or not, that is, if a collection is generated or loaded from a sub-object-model in a certain hierarchy location, and a collision occurs with another object model element with the same id, where the colliding object model element is an attribute, then it would be configurable behaviour if this is permitted or not.

In certain embodiments, merging may also occur between model elements created in the skeleton model or defined in files. That is, an identity conflict may occur because a model element was defined in a file-based sub-object model, that was also defined by a file system item (file or folder representing model elements).

In some embodiments, where merging occurs across a folder that represents an object, such that there may be two interesting folders named “settings” and “settings (development)”, the merging will occur in order of least specific to most specific. That is, “settings” will be generated first as it does not specify a filter, and then “settings (development)” will be generated and merged-in/layered-in afterwards as it is more specific. In some embodiments, where merging occurs across a folder that represents an object, such that there may be three or more matches at the same folder level (“settings”, “settings(development)”, and “settings(development, dev %)”, typically this would be flagged as an ambiguous layout error as it would be difficult to guess which order would be applied in loading from file system items, although in alternative implementations there may exist fixed rules on how layering is structured for 3 or more variants.

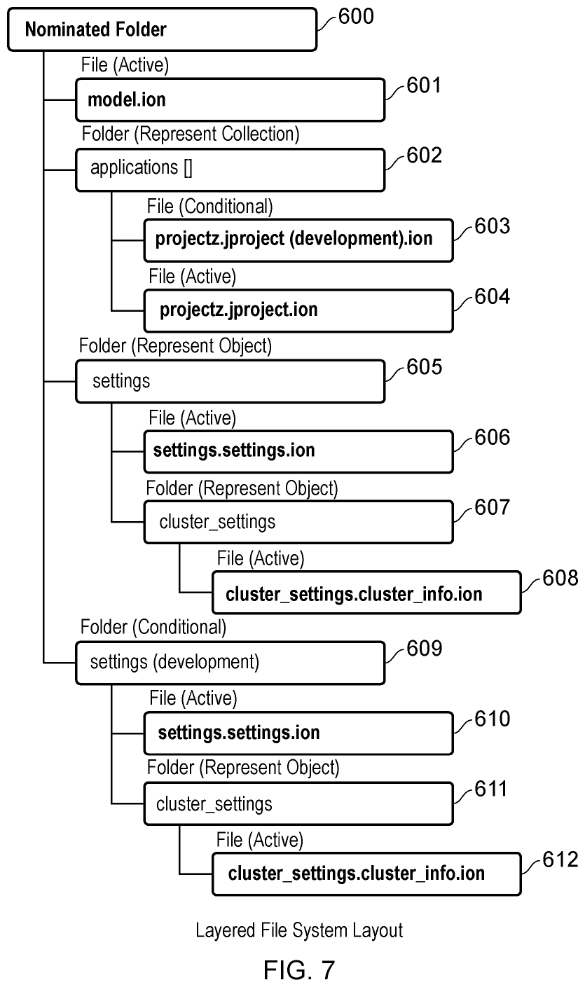

A sample layout of using overlapping identifiers on file system items (files and folders) underneath a nominated folder can be seen in FIG. 7. In this diagram, underneath a single generated collections element “applications [ ]” 602, there exists “projectz.jproject (development).ion” 603 and “projectz.jproject.ion” 604. The order of files 603 and 604 on the file system is irrelevant. Both 603 and 604 appear at the same file system level, and both filenames can be parsed during metadata extracting step S203 to extract the same id “projectz” for both files. In the case that “merging/layering” is not supported by an embodiment or that the merge strategy is “disabled”, two items resolving to the same identifier at the same hierarchical level would result in an exception being thrown by the algorithm.

In the event that “merging/layering” is supported in one of the strategies described above, then the least specific item would be recursively instantiated first. That is, if there are two items, and one item does not have an environment filter that has been extracted from the file or folder name during the metadata extracting step S203, then that is the least specific item. So, in FIG. 6, “projectz.jproject.ion” 604 is less specific than “projectz.jproject (development).ion” 603. So, when processing the contents of “applications [ ]” 602 (which generates a collection object model element), underneath the created collection “applications” an object is created with id “projectz” and type “jproject” corresponding to the “projectz.jproject.ion” 604 file. Typically the contents of root elements of the sub object model represented by the “projectz.jproject.ion” 604 file are then added to the generated element.

Upon creating the object corresponding “projectz.jproject.ion” 604, assuming our context parameters have an environment setting of “development”, then the “projectz.jproject (development).ion” 603 is parsed, and its contents are applied over the object generated by the 604 file (as per the merge policy provided in the context parameters or embodiment specific default).

Similarly, in the example file layout detailed in FIG. 7, “Settings” 605 is instantiated first, typically fully recursively instantiated, then assuming our context parameters have an environment setting of “development”, then “settings (development)” 609 is instantiated afterwards independently, then the object hierarchy generated in 605 (which would contain any sub-object model data within that file system branch already attached) is then merged (as per the merge policy provided in the context parameters or embodiment specific default) with the object instantiated from “settings (development)” 609 (which would contain any sub-object model data within that file system branch already attached).

Typical implementations or merging/layering work optimally with a “recursive” tree building algorithm. Each branch is generated from root to leaf node, and attached to its parent. In FIG. 7, assuming our context parameters have an environment setting of “development”, then even though “settings.settings.ion” 606 and “settings.settings.ion” 610 do not exist in the same file system folder, they exist logically in the same logical hierarchy element and as such, due to the least-specific to most specific merge/layering pattern of their parent object folders, “settings” 605, and “settings (development)” 610, both 606 and 610 will collide and merge when 605 and 610 are merged (as per the merge policy provided in the context parameters or embodiment specific default) and merges will be applied in the correct order. The advantage of this approach is the ability to create environment-specific overrides that mirror a file system structure that provides common values across all environments. The contents of “cluster_settings.cluster_info.ion” 608 and “cluster_settings.cluster_info.ion” 612 will also be directly merged/layered (as per the merge policy provided in the context parameters or embodiment specific default) together based on the identical logical ancestry.

In typical implementations, examples of the invention can be used by user, such as an application developer, using conventional computing equipment, for example a personal computer on which is running a conventional operating system including a hierarchical filesystem, such as Microsoft Windows.

In use, the user creates a nominated folder as described above containing folders, sub folders and files using suitable computer equipment (e.g. a personal computer). The nominated folder can be the root folder of a file system or virtual file system.

The folders, sub folders and files are named and arranged using the conventions detailed above. At least some of the files comprise sub-object model data, in a suitable object notation format.

The computing equipment (e.g. the personal computer) has installed thereon an object model generating computer program, arranged in accordance with examples of the invention, which implements an example of the “algorithm” as detailed above.

When the application developer wishes to generate an instance of the object model from the content of the nominated folder, the user runs the object model generating computer program which generates an instance of an object model as described above.

In some embodiments, the object model generating computer program includes a suitable interface which allows the user to control aspects of the generation of the object model. For example, the interface allows the user to select the nominated folder and to specify context parameters to be passed to the algorithm when generating an instance of an object model.

In other embodiments, the object model generating computer program is configured to perform the generation of the object model according to configured parameters, without a user interface.

As described above, the algorithm generates object model instances in an appropriate format for example XML-DOM, JSON, or custom object model representation (such as the one described throughout this document). The object model generating computer program can be arranged to output the generated instance of the object model to a specific location in the memory of the computing equipment.

Some aspects of the invention may not be able to be natively represented by certain object model representations. For example, XML-DOM does not support the concept of collections, however, collections can be represented using a certain patterns of XML-DOM nodes and XML-DOM attributes to represent a collection. In this case, it may be that the object model referred to in this document can be represented in an XML file, even if the in-memory representation is not natively possible in the file format. The same concept apples to YAML and JSON (which both do not have the native concept of object type). This translation can occur anytime but is especially relevant at time of parsing sub-object-models—which may represent a rich typed object model—hosted in non-typed markup language or object notation. That is, the logical object model extracted from files does not have to be the same as the parser output for the files. There may be transformations required in order to construct the desired in-memory object model from XML, JSON or similar.

In this way an instance of an object model can be generated and readily distributed in order to facilitate downstream operations which require rich hierarchical object models such as complex application configuration or code generation.

In certain embodiments of the invention, conventional computer networking techniques can be used to allow multiple users (for example a team of application developers) to work together on the generation of object models.

For example, a server can be provided on which is running an operating system which includes a suitable filesystem. All of the users have access to the server and as a result all users can contribute to the generation of root folder. Different tasks may be divided amongst the users, for example, particular users may be responsible for generating folders and files relating to particular embedded filters (such as “development” or “production”) or responsible for developing particular folders and files.

An instance of an object model can be generated as described above by one of the users running an instance of the object model generating computer program, on their own computing equipment, using a nominated folder stored on the server (in a conventional or virtual file system). The object model generating computer program may take the nominated folder stored on the server as the input but be run on the user's individual computer equipment (for example their personal computer). The generated instance of the object model can be output to a memory location on the users own computer equipment, or alternatively, to a designated memory location on the server. In other embodiments, the object model generating computer program can be installed and run on the server.

As described above, embodiments of the invention can be implemented as an object model generating computer program installed and run on computer equipment, such as a personal computer or a server. In examples of the invention, the object model generating computer program can be run on a single processor unit (e.g. on a user's laptop), or across multiple processors using data distributed processing techniques as are known in the art.

Object model generating computer programs in accordance with examples of the invention can be stored on any suitable media (a computer program product) as is known in the art, for example on CD-ROMs, solid-state memory devices and so on. Object model generating computer programs in accordance with examples of the invention can be distributed using “online” software distributing techniques, as are known in the art, for example whereby a user, or group or users, purchase the software and the software is downloaded from a server operated by a software merchant.

In certain embodiments, access to the object model generating computer program may be provided remotely via an interface using “virtual computing” techniques. In such embodiments a user is provided with an interface on a terminal (for example a personal computer), but the object model generating computer program is actually run at a remote computer equipment, for example a server.

Technique Using Junction Points

There now follows a description of a second technique which can be used in conjunction with the object model instance generating technique described above. This technique pertains to a method of using a meta-schema (a kind of blueprint for valid data structures) to support certain tooling automations in integrated development environments (IDEs), but also to generate a configuration (or model) archetype.

An advantage of the object model instance generating technique described above is that a large object model can be distributed across a file system, so that visibility is readily achieved, and granularity of configuration at the level of individual concerns is provided (connections might all be under a folder called “connections [ ]”, screen layouts might all be under a folder called “screen_layouts [ ]”). It makes editing, copying and pasting, and source control very easy indeed.

This second technique provides a means by which the previously described object model generating technique can be constrained and focused. As detailed below, this second technique relates to how a meta-schema might describe classes, interfaces, mixins and fields, such that they map optimally onto the object model concept of attributes, collections and objects described above. This technique also relates to how to decide if by default to represent the content of an object within the sub-object-model file, or within some sub-file-system file or folder element. The “junction” concept is central to this technique.

Junctions have two core benefits. They allow for the easy creation of an “archetype”, which is a template layout of given user schema, and they allow for tooling/IDEs (such as Visual Studio) to be aware of the layout so that context sensitive features and validations can be customised to the layout.

More specifically, this second technique relates to a method of utilizing “junction points” within or together with a meta-schema, so that said junction points can be used to implicitly lay out where certain parts of the meta-schema backed data model should reside on the file system (relative to the base configuration folder).

Schema

A schema is a template describing how data or model should be structured/organised.

Meta-Schema

A meta-schema is a type of schema that describes the structure and content of other schemas.

A meta-schema as it pertains to this technique is a meta-schema that is defined such that it describes object-oriented-like class hierarchies, optionally describes interfaces hierarchies, and optionally describing field contributors such as mixins.

For each defined class in the meta-schema defined there will be a zero or more identified fields present in the class. Fields can be contributed to classes through declaring directly within a class, hierarchical class inheritance, or through hierarchical association with field contributors such as mixins.

The concept of interfaces and mixins are optional. Some embodiments of this technique may not include interface hierarchies or mixin hierarchies or other types of field contribution hierarchies.

Interfaces and mixins may be part of the same hierarchical family or different hierarchies. A mixin may extend an interface. An interface may extend an interface.

Classes may associated themselves with the interface hierarchy or mixin hierarchy or mixin/interface hierarchy (if mixins and interfaces are part of the same hierarchy).

Classes can be declared to be concrete in the meta-schema, some embodiments may also support “abstract” classes, which are classes that cannot be directly instantiated but rather exist for the purpose of inheritance by sub-classes.

In some embodiments, classes can implement one or more interfaces.

In some embodiments, classes may extend one or more classes, in other embodiments they may optionally extend one other class exactly, in other implementations they may not extend any other class.

A meta-schema must always have one entry point class identified. The entry point class must be concrete.

Mixins are field containers that may contain one or more fields.

Fields are declared to have an identifier, and a type.

Meta-Schema Field Types

Standard basic field types can include Strings (text), integers, longs, floating point values, enumerations, lists of strings, sets of strings, or binary values.

Fields may also be defined as references to instances of classes or interfaces defined elsewhere in the meta-schema.

Fields may also be single instances of contained objects. An “instance” type field will have a target type. A target type will typically be a class or interface or mixin with one or more concrete classes associated with it.

Fields may also be collections (lists or ordered maps or unordered maps) of objects of a different type (class or interface or mixin).

Fields will typically be flagged as optional or mandatory fields.

Certain field types, such as collections, will be contain cardinality information (such as zero or more items required, one or more items required, between 5 and 10 items required etc).

Fields may contain information on sample values or default values for the field (if no value is specified by the user).

Some fields may be flagged as “fixed” or “non-user-configurable”. These fields are ignored for the purpose of the algorithm.

A collection type field (ordered maps, unordered maps, lists) will have a target type. This will be either an interface or a class. There may be zero or more concrete classes that implement the target type.

Junctions

As mentioned above, examples of this technique are centred around the concept of “junctions”. Junctions are fields within a class that can be represented either within the file corresponding to the containing object, or via additional filesystem elements arrange hierarchically below the current file or folder representing the current object on the filesystem (in distributed object model creation mode).

There are two main categories of junctions.
1. Instance junctions (represents a contained instance of an object)
2. Collection (such as lists/unordered map/ordered map) junctions

Instance Junctions

Instance junctions correspond to fields within a class of type “instance” (or equivalent terminology).

For example, if there exists a class named “compiler” and within the “compiler” class there is a field named “compiler_settings” (which could also be contributed by a mixin or superclass), then field “compiler_settings” is an instance field type of class type “compiler_settings”, and compiler settings can be represented inside the file that represents the class or it could be represented by a sub-folder named “compiler_settings”, underneath the folder that represents the “compiler” class.

It is anticipated that in common embodiments, instance junctions would default to “same file” policy.

Collection Junctions

Collection junctions are fields of type “ordered map” or “unordered map” or “list” (or equivalent terminology).

Collections instances can be represented within the file corresponding to the parent object. If they are represented in this way, then they are leaf-nodes in that all sub-contents of items within the collection must be represented in the same file.

Collections instances can also be represented by a file system element. Typically, collections are represented by a folder such as “my_collection_name [ ]” (with the “[ ]” suffix). This is a collection signifier. Within this folder, sub objects can be represented by sub-files, or sub-folders. If represented by sub-files, then they will also be lead-nodes. It means that all of the contents and sub-contents of the object must be contained within the file. If represented by a folder, then further filesystem based junctions are permitted.

Junction Policies

Junction policies are the policies to apply when generating an archetype distributed model from a meta-schema and a nominated folder. The meta-schema may embed these policies into the meta-schema itself, or these policies may be required to be explicitly provided by the user external to the meta-schema. Some embodiments may also allow these junction policies to be overridden by the user or ide or command line or other type of tooling too.

Junction policies are policies that apply to instances and collections (lists/maps), which determine how to generate file system elements. For example, an instance field could be represented in the a file that represents a class, or it could also be represented by a subfolder underneath the parent object instance folder (that relates to the parent class).

Typical junction policies are as follows:
Default—Use the default junction policy for the field type.
None—Do not use file system junction.
Always—Use file system junction

The “default” junction policy will junction or not junction depending on the field type and the invention embodiment type.

Typically, if a policy is not specified, then a default policy will be assumed.
For “instance” field types, typically junctioning will not occur.
For “list” field types, typically, junctioning would not occur.
For “unordered maps” field types, typically junctioning would occur.
For “ordered maps” field types, typically junctioning would not occur.

By utilizing junction policies, either embedded into the meta-schema, or externally provided, the defaults can be overridden.

Associating Classes with Exploded Set of Fields

Classes are associated with fields by traversing through the class hierarchy. A class may be defined in a meta-schema flat or hierarchically. If defined flat, hierarchy may be represented by a reference to the parent class. The hierarchy therefore can be traversed by using the parent of a class in the meta-schema or by looking up the reference or references to the parent class.

The same mechanism can be used for interfaces and mixins (which may be in separate or the same hierarchy). Mixins can contribute fields. Different embodiments may refer to mixins under different names, but if a mixin contributes fields to an associated class or associated classes then we refer to it as a mixin.

As the class hierarchy is traversed, references to the interface or mixin hierarchies are evaluated and also traversed. Any contributed field is added to the class currently being evaluated.

At the end of the process a map of class ids to field contributions is created. It would usually be an error if there were two fields contributed with the same id. This is generally not permitted for reasons of ambiguity.

This calculated map will be referred to as the “class to contributed field map”. The value part of the map will be the contributed field information including field This is a map of class identifiers which is associated with each class identifier being associated with a set of field information, each field being identified. A class may have zero fields.

Top Level Archetype Creation Algorithm (1)

Benefits

The benefit to being able to generate an archetype from a meta-schema is two-fold.
1) Quick ability to generate a distributed configuration from a meta-schema leading to fast efficient development.
2) Using Junction Points to guide integrated development environment autocomplete and model validation.

Inputs
A nominated folder on the filesystem.
A meta-schema instance.
Optionally, junction context parameters.

Outputs
Created files and folders.

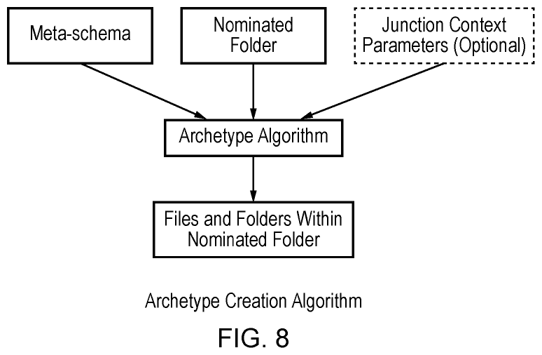

These inputs and outputs are depicted in FIG. 8.

Populating Default Values for Fields in a File

Top-Level Archetype Creation Algorithm Description

Calculate the “class to contributed field map” Create a file (known as the model root file) in the nominated folder corresponding to the entry point class. This will typically be in an object notation and have a common suffix (such as .xml or .json or .ion). In the sample embodiment, we will use “.ion” as the suffix. Call the per-class algorithm with the entry point class id, and a reference to the created file.

Per-Class Archetype Creation Algorithm (Recursive)

The per-class archetype creation algorithm requires a nominated file, and a nominated class id.

Using the “class to contributed field map”, iterate over all fields corresponding to the nominated class id.

Calculate junction policy information for each field, the junction policy typically having a default rule per embodiment and typically being able to be defaulted to a particular value or overridden in the meta-schema instance. Only certain types of fields can be junctioned as described earlier. After applying the policy, it can be determined if a field is junctioned or not. If the embodiment supports “junction context parameters, then interrogate the junction context parameters for overrides that can be provided external to the metaschema when resolving the junction policy for a field in a given class context. That is, that a single field may calculate one type of junction policy if referenced from a particular class than if it is referenced from another via external overrides that may apply at class or field contributor level.

For each non-junctioned user-configurable field, create an entry in the entry point model root file (typically each item would be one per line for trivial single line values or multiple lines for more complex values). Depending on the embodiment, optional or mandatory items may be omitted as per archetyping requirements. Typically, for trivial fields, key value pairs are created in the files. If the field is optional, and a default value for the optional field is specified in the meta-schema, the default value will be output in the “value” part of the file. For complex non-junctioned items, objects or collections can also be created within the file. For each mandatory junctioned field, calculate the file system representation of the field (described earlier), and create the file and folder (for instances), or the folder (for collections). The algorithm may also optionally iterate over optional junctioned fields.

As mentioned earlier, for junctioned collections, a folder is created. Upon creating the folder, the target type of the collection is evaluated, and all concrete classes that implement or extend the target type are calculated. One file per target type is created, and the per-class algorithm is called on each created file together with the concrete class id per item. The file names of the created file will typically be a prefix then the class id then the common file suffix (such as “.ion” or “.xml” or “.json”). If the collection type is a map then a default identifier will be provided for each created file. If the collection type is a list, then ordering information may be embedded in the filename as per the object model distribution embodiment. The files that are created are intended to be illustrative of the structure of a good configuration but in some cases will not represent an instance of a model that fully validates. An archetype is not hand-crafted model.

As mentioned earlier, for junctioned instances, a folder is created corresponding to an arbitrarily generated identifier, and a file is created, sharing the same identifier part, a typical identifier might be “my_listbox”. The created file will also be of a type of one of the concrete classes that implements the target type of the instance. That is, if the target type of an instance field is “ui_item”. And “ui_item” is an interface. And if “listbox”, “textbox” and “combobox” implement “ui_item”, then the type that will be generated could be any one of the three concrete classes listed above. This differs from collection junctions, because there is only one position to provide an archetype. When the archetype file is created, for example “my_listbox.listbox.ion”, the per-class archetype creation algorithm will be called on the created file together with the concrete class id corresponding to the selected concrete item.

Archetype Creation Recursion

The algorithm will avoid recursively generating file system items corresponding to classes or junction elements. That is, if when generating file system items, if a class is encountered that is a direct ancestor of the current class, then it does not descend any further. This occurs on a branch by branch basis.

Archetype Creation Variations

An alternative embodiment may involve the junction information being supplied externally from the meta-schema. This may mean that meta-schema contains no information on junctions, or it may mean that junction information specified in the meta-schema can be overridden from an external source.

An alternative embodiment may involve specifying a list of “environments”, which are textual values, and generating a file system such that specified file-system junctions are exploded per-environment. As an example, the values “dev”, “uat” and “prod” may be supplied to the algorithm, associated with the “connections [ ]” junction, together with a flag used to indicate that a “default” (no environment) junction should be generated or not, and instead of generating “connections[ ]” junction as a folder on the file system, it could generate 4 folders “connections [ ]”, “connections [ ] (dev)”, “connections [ ] (uat)”, “connections [ ] (prod)”. Each folder would then fully resolve downwards.

Optional fields may also be iterated over depending on the embodiment, or configuration of the algorithm.

IDE Mapping (2)

A further benefit of the junction mechanism is that tooling is aware of the layout of an instance of a meta-schema. In the context of a file corresponding to a class in the meta-schema, pressing the code completion key combination will typically result in a list of items that expected in the current context.

When in a “distributed context”, junctioned items are not suggested for code completion within the parent class context. When in a non-junctioned context, all mandatory user-configurable items that are expected underneath a class will be suggested. That is, the code editor is aware of the junctioning policies. It should be noted that junctioning policies may be overridden per meta-schema or per distributed instance of a meta-schema within the tooling itself (but will use the meta-schema default junctioning policies if policies are supported by the embodiment).

When in a distributed context, the IDE is able to process files in isolation, validate each file individually according to the validation rules that exist in the absolute local context of object (and corresponding class id) for which the user is editing. A secondary level of validation will allow for validations of the distributed model, but this type of validation typically might occur when a file or folder is created, modified or deleted. Junctions make it simple to support local validations and distributed (or full model) validations.

One UI pattern is that items can be suggested in code completion, and upon selection of the item, a “wizard” dialog box is displayed asking for the identifier and the type of the model element item to be created on the file system underneath the current file system context.

Upon selecting the item id and the type, the archetype process will be triggered (as described here), and an archetype will be created for the file. The archetype may optionally omit file contents, or can be configurable.

Another UI pattern is that clicking, right clicking, long pressing or otherwise context selecting on a folder representing a collection will present either a wizard or a dialog suggesting concrete class instance that can be created in the folder. It does this by starting at the top of the distributed model then crawling through each parent junction to the current collection junction, and then resolves the target type for the collection junction. From the target type, the meta-schema can be used to resolve concrete classes that implement the target type, and those options will be presented to the user in either wizard form or via an in-place selection dialog.

Another UI pattern is clicking, right clicking, long pressing or otherwise context selecting on an editor panel, editor header, or navigator UI item that represents a filename that corresponding to an instance of an object or an object instance within a collection, and being presented a list of junctioned items that can be created underneath the outer object. That is, for example, if right clicking on folder corresponding to class type “settings”, and if there are no current items called “vm_settings”, and “vm_settings” is a junctioned instance, then the user would be presented with a context sensitive dialog or pop up UI item giving the user the option to create “vm_settings”. If “vm_settings” is the target type of the instance, and there are multiple concrete classes that implement the target type, then the UI will let the user select the class type to create. The id will be fixed as per the defined fields for the current class.

Another UI pattern is clicking, right clicking, long pressing or otherwise context selecting on an editor panel, editor header, or navigator ui item that represents a filename that corresponding to an instance of an object or an object instance within a collection, and being presented with the option to “split” the item across environments (in addition to previously detailed options). In this scenario, the user will be presented with a UI dialog box or screen, and given the option to split the current configuration across one or more listed environments. In some embodiments that user may have the option to type the environments manually, in other environments, the user may be presented with a selection of previously known environments—either way—if the user selects one or more environments and does not cancel the operation, then one or additional files or file folder pairs will be created for each environment corresponding to the split operation. The additional split items will embed the environment into the environment filter part of the file and/or folder name. For example, for the “dev” environment, folder name “settings (dev)” and file name “settings.setting (dev).ion”.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of generating an instance of an object model from content of a hierarchical file system, said content of the hierarchical file system comprising folders and files, said method comprising:
generating elements within the instance of the object model, each element corresponding to at least one of the files or folders of the hierarchical file system,
wherein each element is defined in accordance with a name of the file or folder, or plurality of files and folders, to which it corresponds and occupies a hierarchical position within the instance of the object model corresponding to a hierarchical position of the file or folder to which it corresponds; and
generating one or more sets of further elements within the object model, each set of further elements defined by a sub-object model contained within a different one of the files, wherein each set of further elements occupies a hierarchical position within the instance of the object model corresponding to a hierarchical position within the hierarchical file system of the file to which it corresponds.

2. A method according to claim 1, wherein the sub-object models contained in the files of the file system are represented using an object notation format.

3. A method according to claim 2, wherein the object notation representation is in accordance with JSON object notation, XML object notation or YAML object notation.

4. A method according to claim 1, wherein the files of the hierarchical file system are stored a predefined nominated folder.

5. A method according to claim 1, wherein the generated elements of the instance of the object model include objects.

6. A method according to claim 1, wherein the generated elements of the instance of the object model include collections.

7. A method according to claim 6, wherein a collection is a sequence of objects.

8. A method according to claim 1, wherein the generated elements of the instance of the object model include attributes.

9. A method according to claim 1, further comprising, while generating the elements of the instance of the object model, ignoring selective folders and/or files based on a predefined prefix or suffix in the name of the folder and/or file.

10. A method according to claim 1, wherein a merging strategy is employed to handle collision and/or layer inserts between object model elements generated with the same identification at the same hierarchical position.

11. A method according to claim 1, wherein an order with which object model elements are generated within a given hierarchical level of the instance of the object model is defined using a predetermined notation in the folder name or file name.

12. A method according to claim 1, further comprising:
determining whether a folder or file includes a predefined filter in its name, and upon a positive determination, while generating the elements of the instance of the object model ignoring the folder or file unless the predefined filter matches a predetermined condition.

13. A method according to claim 12, wherein the predetermined condition is based on a predetermined parameter.

14. A method according to claim 13, wherein the predetermined parameter is a text string.

15. A method according to claim 14, wherein the predetermined condition is based on whether the text string matches at least part of the text string.

16. A method according to claim 1, wherein the hierarchical file system is an operating system native file system.

17. A method according to claim 1, wherein the file system is a virtual file system.

18. A system comprising one or more processors and a computer program product storing instructions that, when executed by the one or more processors, cause the processors to perform operations comprising:
generating elements within an instance of an object model based on content of a hierarchical file system, the content comprising folders and files, and each element corresponding to at least one of the files or folders of the hierarchical file system,
wherein each element is defined in accordance with a name of the file or folder, or plurality of files and folders, to which it corresponds and occupies a hierarchical position within the instance of the object model corresponding to a hierarchical position of the file or folder to which it corresponds; and
generating one or more sets of further elements within the object model, each set of further elements defined by a sub-object model contained within a different one of the files, wherein each set of further elements occupies a hierarchical position within the instance of the object model corresponding to a hierarchical position within the hierarchical file system of the file to which it corresponds.

19. A computer program product storing computer readable instructions that, when executed by a system of one or more processors, cause the system to perform operations comprising:
generating elements within an instance of an object model based on content of a hierarchical file system, the content comprising folders and files, and each element corresponding to at least one of the files or folders of the hierarchical file system,
wherein each element is defined in accordance with a name of the file or folder, or plurality of files and folders, to which it corresponds and occupies a hierarchical position within the instance of the object model corresponding to a hierarchical position of the file or folder to which it corresponds; and
generating one or more sets of further elements within the object model, each set of further elements defined by a sub-object model contained within a different one of the files, wherein each set of further elements occupies a hierarchical position within the instance of the object model corresponding to a hierarchical position within the hierarchical file system of the file to which it corresponds.

20. (canceled)
